(19) United States
(12) Patent Application Publication
(10) Pub. No.: US 2017/0308625 A1
(43) Pub. Date: Oct. 26, 2017

(54) COMPUTER-READABLE RECORDING MEDIUM, ROAD CONSTRUCTION PLANNING METHOD, AND INFORMATION PROCESSING APPARATUS

(71) Applicant: FUJITSU LIMITED, Kawasaki-shi (JP)

(72) Inventors: Hiroshi SASAKI, Meguro (JP); Hiroyuki TANI, Katsushika (JP); Sei MASUDA, Kagoshima (JP); Shinichi TANI, Oota (JP)

(21) Appl. No.: 15/648,960

(22) Filed: Jul. 13, 2017

Related U.S. Application Data
(63) Continuation of application No. PCT/JP2016/050889, filed on Jan. 13, 2016.

(30) Foreign Application Priority Data
Jan. 16, 2015 (JP) 2015-007203

(51) Int. Cl. G06F 17/50

(52) U.S. Cl. CPC G06F 17/50

(57) ABSTRACT

A non-transitory computer-readable recording medium has stored therein a program that causes a computer to execute a process including: receiving specification of a line; receiving specification of a type of road repair construction for each of plural sections included in a road corresponding to the specified line; and executing control of displaying a mark corresponding to the received type, in association with each of the plural sections on the road corresponding to the line.

### CROSS-REFERENCE TO RELATED APPLICATION(S)

This application is a continuation of International Application No. PCT/JP2016/050889, filed on Jan. 13, 2016, which is based upon and claims the benefit of priority of the prior Japanese Patent Application No. 2015-7203, filed on Jan. 16, 2015, the entire contents of which are incorporated herein by reference.

### FIELD

The embodiment discussed herein is related to a computer-readable recording medium, a road construction planning method, and an information processing apparatus.

### BACKGROUND

Many roads are managed by municipalities, such as prefectures, cities, towns, and villages. Municipalities are demanded to implement construction for repairing deteriorated roads (also referred to as “lines”) within limited budgets, and to maintain their roads to be managed. Thus, upon budget implementation, municipalities form plans of road construction by allocating budgets according to situations of the deteriorated roads.

However, there are various types of road construction for repair, and forming a plan of road construction by specification of a type of road construction for each section of a line involves difficult verification work.

For example, when road construction is planned, in consideration of circumstances, such as degree of deterioration and traffic, which differ among sections of a line, a type of road construction is specified for each section. Checking correspondence between the sections of the line and the specified types of road construction, and verifying that an appropriate type of road construction has been specified for each of the sections of the line are important, but this verification work is not easy (see, Japanese Laid-open Patent Publication No. 2004-220586).

### SUMMARY

According to an aspect of an embodiment, a non-transitory computer-readable recording medium has stored therein a program that causes a computer to execute a process including: receiving specification of a line; receiving specification of a type of road repair construction for each of plural sections included in a road corresponding to the specified line; and executing control of displaying a mark corresponding to the received type, in association with each of the plural sections on the road corresponding to the line.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating an example of a system configuration;

FIG. 2 is a flow chart illustrating an example of operation of an information processing apparatus according to an embodiment;

FIG. 3 is a flow chart illustrating an example of operation of budget simulation processing;

FIG. 4 is an explanatory diagram illustrating construction method data;

FIG. 5 is an explanatory diagram illustrating setting of construction method application standards;

FIG. 6 is an explanatory diagram illustrating detailed settings for simulation;

FIG. 7 is an explanatory diagram illustrating a display screen for the simulation;

FIG. 8 is an explanatory diagram illustrating the display screen for the simulation;

FIG. 9 is an explanatory diagram illustrating the display screen for the simulation; and

FIG. 10 is a block diagram illustrating an example of a hardware configuration of the information processing apparatus.

### DESCRIPTION OF EMBODIMENTS

Preferred embodiments of the present invention will be explained with reference to accompanying drawings. In the embodiments, the same signs will be appended to configurations having the same functions, and redundant description thereof will be omitted. The road construction planning program, the road construction planning method, and the information processing apparatus described in the embodiments below are just examples, and do not limit the embodiments. Further, the following embodiments may be combined with one another as appropriate so long as no contradiction is caused thereby.

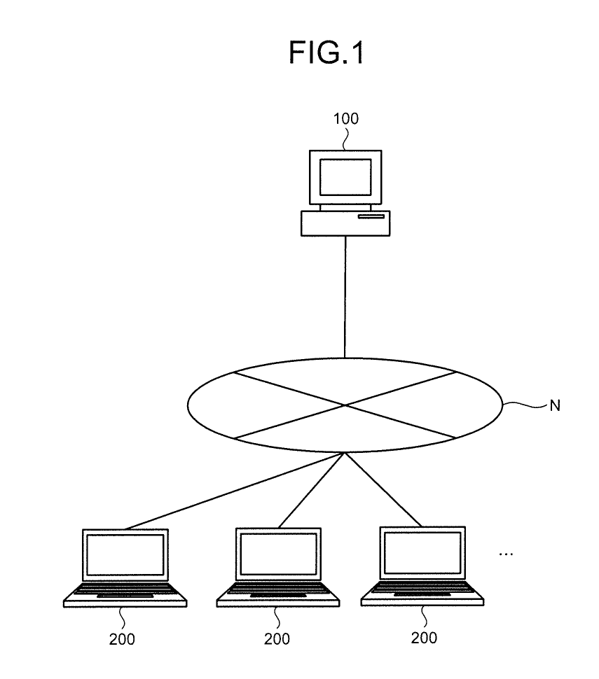

FIG. 1 is an explanatory diagram illustrating an example of a system configuration. As illustrated in FIG. 1, an information processing apparatus 100 according to an embodiment is a server apparatus that communicatably connects to a terminal apparatus 200 via a network N, such as a local area network (LAN) or the Internet. The terminal apparatus 200 is a personal computer (PC), or the like. The information processing apparatus 100 and the terminal apparatus 200 execute various types of processing by central processing units (CPUs) thereof executing programs (details of hardware configurations thereof being described later). Specifically, by the CPU executing the program, the information processing apparatus 100 executes various types of processing related to planning of road construction. Further, by the CPU executing the program, the terminal apparatus 200 executes: communication with the information processing apparatus 100; graphical user interface (GUI) processing for requesting various types of processing to the information processing apparatus 100 and for displaying results thereof; and the like.

For example, a user, who is an employee of a municipality or the like, carries out an operation for logging into the information processing apparatus 100 from the terminal apparatus 200, and requests the information processing apparatus 100 to display, on the terminal apparatus 200, a GUI screen for performing various operations related to planning of road construction. Subsequently, the user requests the information processing apparatus 100 for various types of processing related to planning of road construction from the GUI screen displayed on the terminal apparatus 200. Based on the requests for processing received from the terminal apparatus 200, the information processing apparatus 100 executes various types of processing related to planning of road construction, and outputs results of the processing to the terminal apparatus 200. Thereby, the user is able to perform, at the terminal apparatus 200, work related to formation of a road construction plan. The information processing apparatus 100 may have a function of executing GUI processing by itself, receive requests for various types of processing related to budget allocation or the like from the user through an input device, and display results of the processing on a monitor.

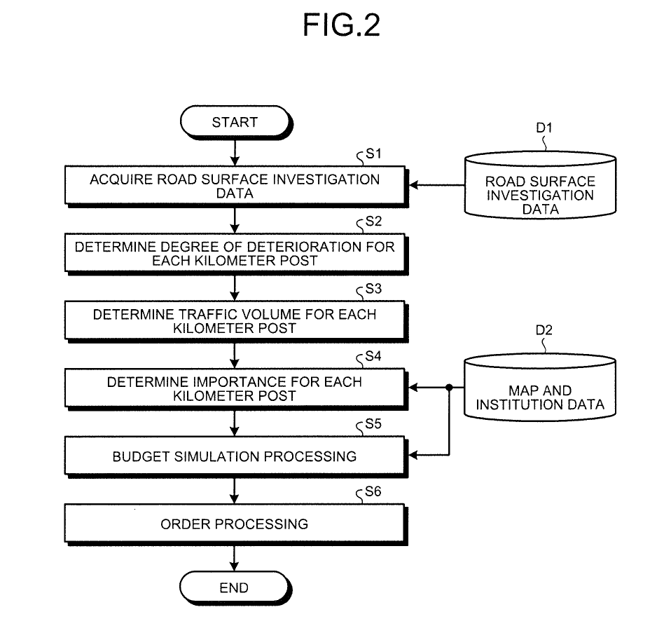

FIG. 2 is a flow chart illustrating an example of operation of the information processing apparatus 100 according to the embodiment. The information processing apparatus 100 executes various types of processing of S1 to S5 illustrated in FIG. 2, by the CPU executing a program.

Firstly, when processing is started, the information processing apparatus 100 acquires road surface investigation data D1 from a storage, such as a hard disk device (S1). The road surface investigation data D1 are data indicating investigation results of investigation of actual states of a road managed by the municipality. In the road surface investigation data D1, for each section (kilometer post) of the road, information indicating at least degree of deterioration of a road surface thereof, and information indicating traffic of vehicles traveling in that section per unit time, are described.

The information indicating the degree of deterioration of the road surface in the road surface investigation data D1 may be, for example, data resulting from evaluation of the degree of deterioration into different grades when an investigator investigates the road surface for each kilometer post. Further, the information indicating the degree of deterioration of the road surface may be captured data acquired by image capturing of the road surface with a camera for each kilometer post. The captured data for each kilometer post may be collected by a vehicle for investigation being caused to travel, the vehicle having been installed with a global positioning system (GPS) and a camera for image capturing of road surfaces.

The information indicating the traffic in the road surface investigation data D1 may be, for example, results of traffic volume investigation performed by an investigator for each kilometer post. Further, the information indicating the traffic may be a value acquired by passing vehicles being counted from data captured by a fixed point camera arranged at a predetermined position of the road. This traffic volume may be collected for different car types, such as passenger cars and trucks, or for different time zones, such as daytime and nighttime.

Subsequently, the information processing apparatus 100 determines, based on the information indicating the degree of deterioration included in the acquired road surface investigation data D1, the degree of deterioration of the road surface for each kilometer post (for example, five grade evaluation or point evaluation (S2). Specifically, in the case of the data acquired as a result of the investigator evaluating the degree of deterioration into different grades, that evaluation is determined as the degree of deterioration. Further, in the case of the captured data acquired as a result of image capturing of the road surface, the captured data may be displayed on a monitor or the like, and evaluation by a user may be received and determined through an input device. Furthermore, the information processing apparatus 100 may recognize states of the road surface as different grades from the captured data resulting from image capturing of the road surface by known image recognition processing, and determine results of the recognition as degrees of deterioration.

Subsequently, the information processing apparatus 100 determines, based on the traffic included in the acquired road surface investigation data D1, an amount of traffic for each kilometer post (S3). Specifically, the information processing apparatus 100 performs graded evaluation (for example, into three grades of A to C), based on the traffic (traffic volume) at the corresponding kilometer post.

For example, the information processing apparatus 100 focuses on the number of trucks that have passed per month from the traffic, and if that value is equal to or larger than 100, evaluates the grade as B, and if that value if less than 100, evaluates the grade as C.

Subsequently, based on map and institution data D2 read out from a storage, such as a hard disk device, the information processing apparatus 100 determines importance for each kilometer post (S4).

The map and institution data D2 are data, in which a map of a region managed by the municipality, a position of the road, and information related to an environment, such as institutions, on the map, are described. Specifically, in the map and institution data D2, a position each of the kilometer posts of the road managed by the municipality and a range thereof are described with a latitude, a longitude, an address, and the like. Further, in the map and institution data D2, a position of an institution on the map (latitude, longitude, address, and the like), and information indicating a classification of the institution, such as school, hospital, or public office, are described. Further, the information related to the environment on the map may be any data as long as the data indicate the environment, in which investigation has been performed with respect to the position (latitude, longitude, address, and the like) on the map. For example, the data may be demographic statistics (daytime population, nighttime population, and the like), traffic accidents and their causes (heavy braking, speeding, and the like), use districts according to urban planning law (residential district, commercial district, and the like), or the like.

For example, the information processing apparatus 100 adds points to a score for evaluation of the importance, based on environmental factors acquired from the map and institution data D2. For example, the information processing apparatus 100 executes point addition of ten points for a position where accidents due to heavy braking have frequently occurred (five times or more over the last year). Further, if the position is near an institution, such as a school, a hospital, a public office, or a station (one kilometer or less from this target institution), 20 points are added. Furthermore, if the daytime population therearound is twice, or more than twice the nighttime population, ten points are added.

Based on the score that has been added with points based on the environmental factors, such as the institution, acquired from the map and institution data D2, the information processing apparatus 100 evaluates the importance. For example, the importance is evaluated: as “C”, if 0≦(score)<50 points; as “B”, if 50≦(score)<100; and as “A”, if 100≦(score).

Subsequently, the information processing apparatus 100 receives settings for conditions of simulation, such as a line to be subjected to road construction and an amount of budget, through a GUI, from the user, and executes budget simulation processing (S5).

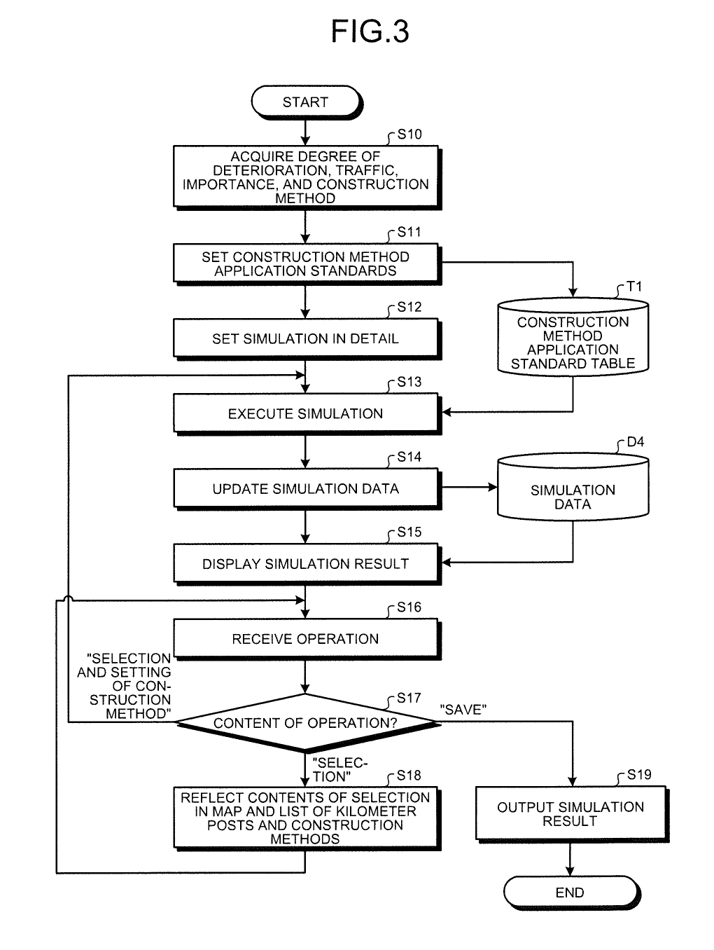

Details of the budget simulation processing (S5) will now be described. FIG. 3 is a flow chart illustrating an example of operation of the budget simulation processing.

As illustrated in FIG. 3, when the budget simulation processing is started, the information processing apparatus 100 acquires the degree of deterioration, traffic, and importance evaluated and determined for each kilometer post, as well as construction methods of road construction (S10). Specifically, the degree of deterioration, traffic, and importance, for each kilometer post are the degree of deterioration for each kilometer post determined at S2, the traffic for each kilometer post determined at S3, and the importance for each kilometer post determined at S4. The information processing apparatus 100 acquires the degree of deterioration, traffic, and importance, for each kilometer post, which have been determined through S2, S3, and S4 and saved in an internal memory or the like. Further, the information processing apparatus 100 acquires, as the construction methods of road construction, information on various construction methods to be specified for the respective kilometer posts and a unit cost of each of the construction methods (for example, a unit cost per unit length), from construction method data stored in a memory or the like.

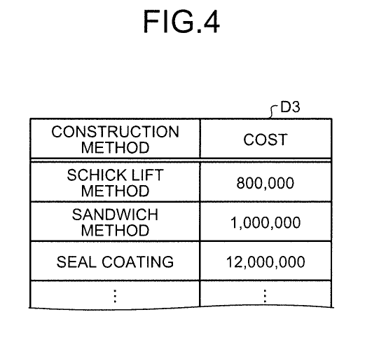

FIG. 4 is an explanatory diagram illustrating construction method data D3. As illustrated in FIG. 4, in the construction method data D3, unit costs of construction methods are described for the respective construction methods, such as “schick lift method”, “sandwich method”, and “seal coating”. These construction method data D3 are set in advance by setting executed through input of the construction methods and the unit costs, via the GUI. The information processing apparatus 100 is able to acquire various construction methods and a unit cost for each construction method, by referring to the construction method data D3.

Subsequently, the information processing apparatus 100 receives, from the user, through the GUI, settings for construction method application standards (S11). The construction method application standards define, as standards, types of construction methods to be applied, in order of costs (for example, in order of “construction method (high)”, “construction method (medium)”, and “construction method (low)”), to grades indicated by the degree of deterioration, traffic volume, importance, and the like of the road. In simulation for determination of a construction method of road construction for each kilometer post, types of construction methods defined by the construction method application standards for the grades of the respective kilometer posts are presented as initial candidates.

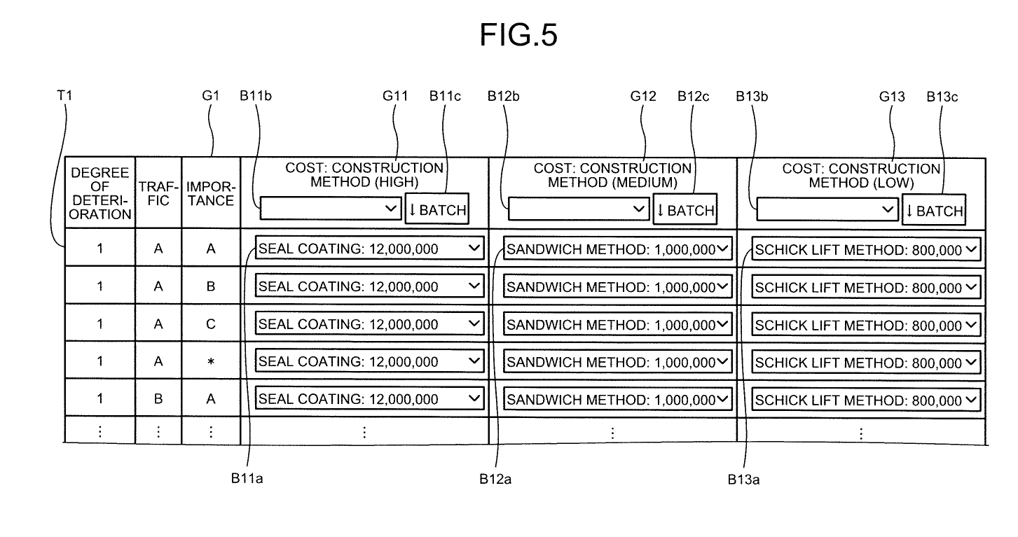

FIG. 5 is an explanatory diagram illustrating setting of the construction method application standards. As illustrated in FIG. 5, through the GUI for setting of the construction method application standards, for respective grades of the degree of deterioration, traffic, and importance, a construction method application standard table T1 for setting of types of construction methods in the order of costs is displayed, and their settings are received. Subsequently, the information processing apparatus 100 stores the construction method application standard table T1 set by operation through the GUI, on a memory.

Specifically, through construction method selection boxes B11a and B11b and a batch data input button B11c, of a construction method setting area G11, types of construction methods in “construction method (high)” are set for the respective grades. Further, through construction method selection boxes B12a and B12b and a batch data input button B12c, of a construction method setting area G12, types of construction methods in “construction method (medium)” are set for the respective grades. Furthermore, through construction method selection boxes B13a and B13b and a batch data input button B13c, of a construction method setting area G13, types of construction methods in “construction method (low)” are set for the respective grades. In the selection of construction methods with the construction method selection boxes B11a, B12a, B13a, B11b, B12b, and B13b, the construction methods that have been set in the construction method data D3 are made the choices.

For example, as a construction method of “construction method (high)” of a grade where the degree of deterioration, traffic, and importance are respectively “1”, “A”, and “A”, a construction method, which is selected through the construction method selection box B11a from the construction methods that have been set in the construction method data D3, is set. Similarly, construction methods are set: for “construction method (medium)”, by selection through the construction method selection box B13a; and for “construction method (low)”, by selection through the construction method selection box B13a.

The batch data input button B11c, B12c, or B13c is a button for setting a construction method selected through the construction method selection box B11b, B12b, or B13b for each of the grades in a batch. For example, if the construction method selection box B11b is operated in a state where “seal coating” has been selected with the batch data input button B11c, like the illustrated example, the construction method, “seal coating”, is set in a batch for “construction method (high)” of the respective grades.

After the setting of the construction method application standards (S11), the information processing apparatus 100 receives, from the user, through the GUI, detailed settings of simulation, such as the line to be subjected to road construction, and the amount of budget (S12).

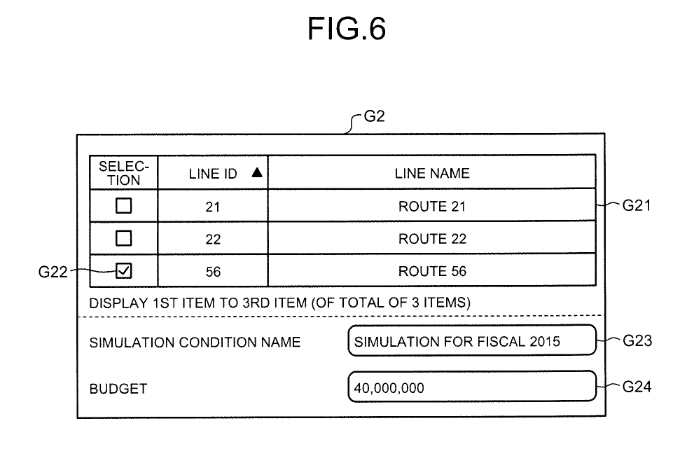

FIG. 6 is an explanatory diagram illustrating the detailed settings of the simulation. As illustrated in FIG. 6, the GUI, through which setting of the simulation is executed in detail, receives, through operations on a setting screen G2, settings, such as the line to be subjected to road construction, and the amount of budget. Specifically, a list of lines is displayed in a line selection area G21 of the setting screen G2, and through selection and specification of a selection box G22, specification of a line to be subjected to road construction is received. Further, through input in input boxes G23 and G24, a simulation condition name, and a condition, such as an amount of budget, are received.

Subsequently, the information processing apparatus 100 executes simulation, in which a combination of types of road construction for the respective kilometer posts is found, in a range where conditions including the amount of budget, are satisfied, for the line to be subjected to road construction, the line having been set through the detailed settings of the simulation (S13).

Specifically, with respect to the line to be subjected to road construction, for each kilometer post, the information processing apparatus 100 acquires types of construction methods in order of costs by referring to the construction method application standard table T1, based on the degree of deterioration, traffic, and importance. Subsequently, the information processing apparatus 100: selects a target kilometer post by a combination of the degree of deterioration, traffic, and importance; further selects a construction method to be applied to that kilometer post; and finds a cost for when that construction method is selected, by referring to the construction method data D3. As to the construction method: the larger the degree of deterioration and the higher the importance, of the kilometer post are; the higher the cost of a construction method preferably selected (for example, “construction method (high)”) is. By totaling of costs of construction expended for the respective kilometer posts, a combination of types of road construction for the respective kilometer posts, the combination staying within the amount of budget, is found. If plural combinations are acquired, evaluation of durable years or the like may be executed from construction methods included in the combinations, and the most highly evaluated combination may be made a result of the simulation.

Based on the result of the execution of the simulation, the information processing apparatus 100 updates simulation data D4 (S14). Specifically, for the line to be subjected to road construction, the result found as the combination of types of road construction for the respective kilometer posts is saved as the simulation data D4. In the simulation data D4, for the line to be subjected to road construction, the combination of types of road construction for the respective kilometer posts, and a total of construction costs are stored. In the execution of the simulation for the first time (S13), the simulation data D4 are generated based on the result of that execution. In execution of the simulation (S13) after the first time, based on a result of that execution, a part different from the past simulation data D4 is updated.

Subsequently, the information processing apparatus 100 refers to the simulation data D4, and causes the simulation result by the execution of the simulation (S13) to be displayed on a display screen (S15).

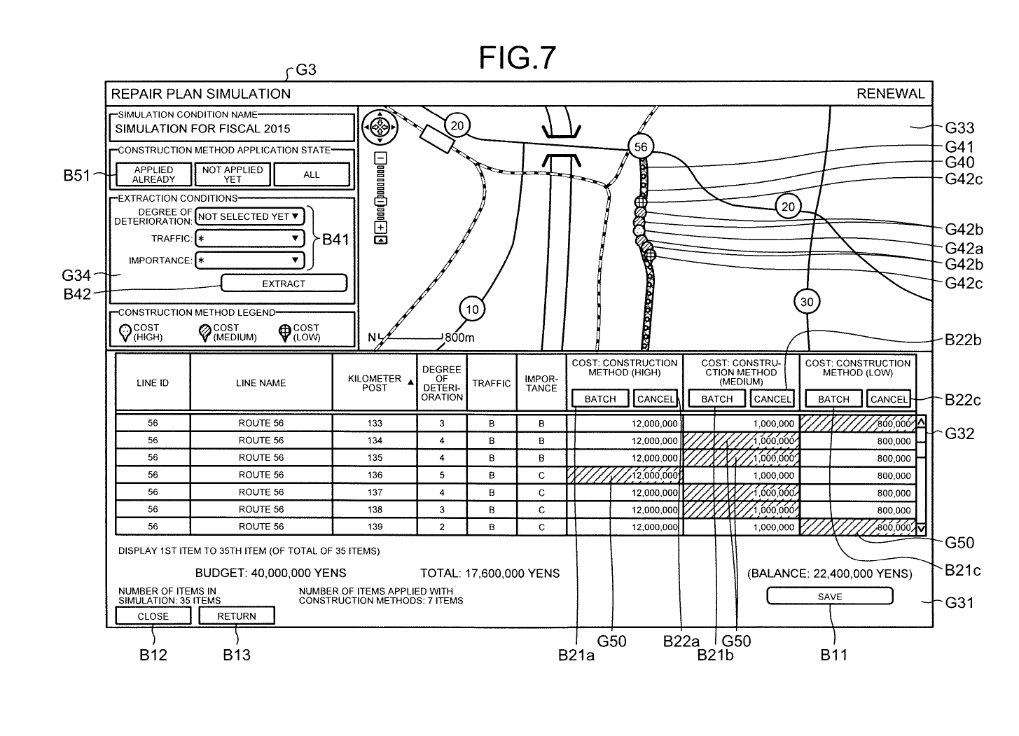

FIG. 7 is an explanatory diagram illustrating a display screen G3 for the simulation. As illustrated in FIG. 7, the display screen G3 has an amount display G31, a list display G32, a map display G33, and a condition setting display G34. Further, the display screen G3 has: operation buttons B11, B12, B13, B21a, B21b, B21c, B22a, B22b, B22c, B42, and B51; and an input box B41.

In the amount display G3; information, such as the amount of budget set through S12, the total of construction costs calculated by the simulation of S13, and the balance remaining after subtraction of the total of construction costs from the amount of budget, is displayed.

In the list display G32; a list of the kilometer posts of the line to be subjected to road construction, the line having been specified at S12, is displayed. Specifically, the information processing apparatus 100 reads out, from the map and institution data D2, information on the kilometer posts of the line that has been specified at S12, and displays a table of the list of the kilometer posts, with each kilometer post being in one line. In columns of this table of the list: in addition to the line ID, the line name, the kilometer posts; the degree of deterioration, traffic, and importance that have been acquired at S10 for each of the kilometer posts, and the construction methods in the order of their costs acquired by reference to the construction method application standard table T1 based on those degree of deterioration, traffic, and importance, are displayed.

Further, in a line of each kilometer post in the list display G32, selective display G50 is executed, based on the simulation data D4, at the type of road construction found as the simulation result. Thereby, the user is able to check the simulation result acquired as the combination of types of road construction for the respective kilometer posts, with respect to the line to be subjected to road construction.

Further, the information processing apparatus 100 receives a selection of the construction method, through a selection from the columns, “construction method (high)”, “construction method (medium)”, and “construction method (low)”, in a line of each of the kilometer posts in the list display G32. Thereby, the user is able to select a construction method that is different from the construction method that is being selected through the selective display G50.

In the map display G33, a map acquired by reference to the map and institution data D2 is displayed. The information processing apparatus 100 executes line display G40 correspondingly to the line that has been specified at S12 and that is to be subjected to road construction (Route 56 in the illustrated example), and enables distinguishment thereof from the other lines (Routes 10, 20, and 30 in the illustrated example). Thereby, the user is able to easily check the line to be subjected to road construction, in the map displayed on the map display G33. Further, the information processing apparatus 100 displays a kilometer post mark G41 at a position of each kilometer post in the line display G40, on the map of the map display G33.

Further, at each kilometer post of the line display G40, a construction method mark G42a, G42b, or G42c, which corresponds to a construction method being selected in a line of the corresponding kilometer post in the list display G32, is displayed. For example, for a kilometer post, “136”, “construction method (high)” is being selected in the list display G32. Therefore, at a position corresponding to the kilometer post, “136”, on the map display G33, the construction method mark G42a corresponding to “construction method (high)” is displayed.

According to presence or absence of display of the construction method mark G42a, G42b, or G42c at each of the kilometer posts, the user is able to check whether or not a construction method has been selected for each of the kilometer posts. Further, by checking types of the construction method marks G42a, G42b, and G42c, the user is able to easily check types of the construction methods for the respective kilometer posts.

In the condition setting display G34, an input box B41 for setting of conditions, such as extraction conditions, and an operation button B42 are displayed. The information processing apparatus 100 receives extraction conditions, such as the degree of deterioration, traffic volume, and importance, through the input box B41, and executes extraction of kilometer posts under the set extraction conditions. Further, by construction method application state selection B51, “construction method applied already” or “unapplied state” is selectively displayed.

The operation button B11 is a button, through which save of the simulation result having the contents displayed on the display screen G3 is instructed. By receiving an operation on the operation button B11, the information processing apparatus 100 saves the simulation result having the contents selected by the selective display G50 for the construction methods of the respective kilometer posts. The operation button B12 is a button, through which an instruction for ending the processing is received. The information processing apparatus 100 ends the processing without saving the simulation result, if the operation button B12 is operated without any operation on the operation button B11. The operation button B13 is a button, through which an instruction for returning to processing before the execution of the simulation is received. The information processing apparatus 100 returns to the previous processing, such as S12, by receiving the operation on the operation button B13.

The operation buttons B21a, B22a, B21b, B22b, B21c, and B22c are each a button, through which an instruction for a batch selection or cancel thereof, for “construction method (high)”, “construction method (medium)”, or “construction method (low)” is received. For example, by receiving an operation on the operation button B21a, the information processing apparatus 100 selects, in a batch, as construction methods of the respective kilometer posts, “construction method (high)”. Further, by receiving an operation on the operation button B22a, the information processing apparatus 100 cancels, in a batch, those “construction method (high)” being selected among the respective kilometer posts. Thereby, the user is able to easily select the construction methods of the respective kilometer posts.

Back to FIG. 3, subsequently to S15, the information processing apparatus 100 receives operation through the GUI (S16), and determines contents of the received operation (S17). The operation through the GUI includes “selection and setting of construction method” by a selection from the columns, “construction method (high)”, “construction method (medium)”, and “construction method (low)”, the selection being executed for a line of each of the kilometer posts in the list display G32.

In the case of this “selection and setting of construction method”, since the construction methods are newly selected, the information processing apparatus 100 executes the simulation over again and updates the display on the display screen G3, and thus returns the processing to S13. At S13, to which the processing has been returned, based on the selected construction methods, the simulation is executed over again. Thereby, on the display screen G3, a result of the simulation reflecting the selected construction methods is displayed.

For example, if, for the kilometer post, “136”, “construction method (low)” is newly selected from “construction method (high)”, simulation is executed over again under conditions where “construction method (low)” has been set for the kilometer post, “136”. Thereby, in the amount display G31, an amount acquired as a result of the execution of the simulation over again is displayed. Further, at a position corresponding to the kilometer post, “136”, on the map display G33, the construction method mark G42c corresponding to “construction method (low)” is displayed.

Further, the operation through the GUI includes “selection”, which may be: a selection from the respective kilometer posts in the list display G32; a selection of the kilometer post mark G41 of the line display G40; a selection of a column in the list display G32; or the like.

In the case of this “selection”, the information processing apparatus 100 causes contents of the received selection to be reflected in the map display G33 and the list display G32 of the kilometer posts and construction methods (S18).

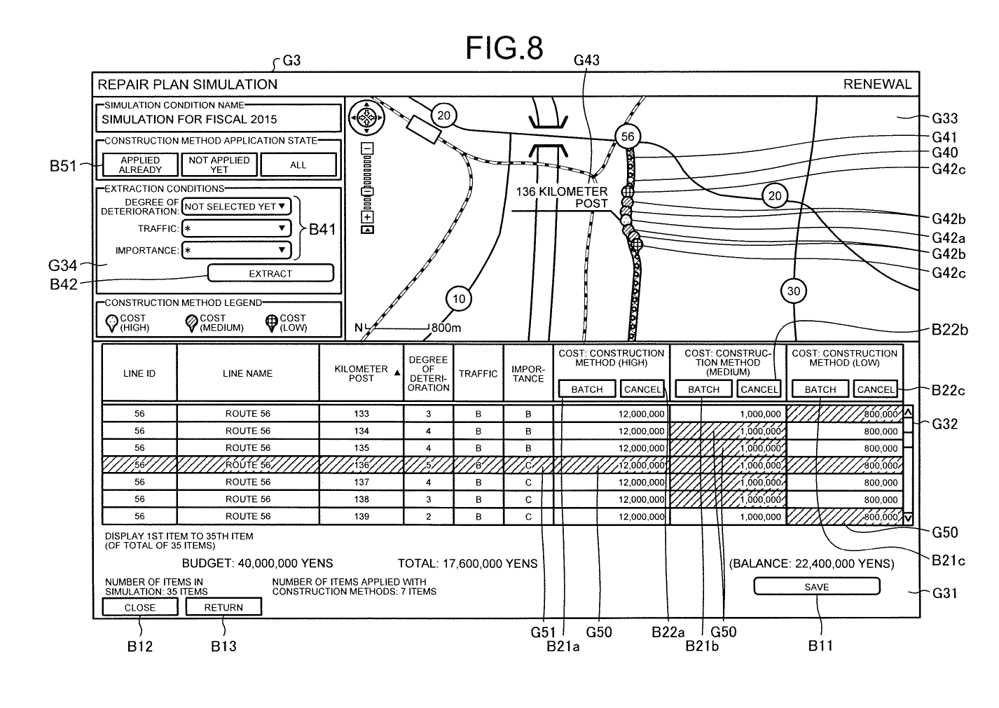

FIG. 8 is an explanatory diagram illustrating the display screen G3 of the simulation, and is a diagram illustrating a case, in which a selection from the respective kilometer posts in the list display G32, or a selection of the kilometer post mark G41 of the line display G40 has been received.

As illustrated in FIG. 8, when a predetermined line is selected in the list display G32, the information processing apparatus 100 executes selective display G51 for the selected line. The information processing apparatus 100 then displays a selection mark G43 at a kilometer post corresponding to the selected line, of the kilometer post marks G41 on the map display G33. With this selection mark G43, a name of the kilometer post corresponding to the selected line may be displayed together. Thereby, the user is able to easily check, from the map display G33, a position of the kilometer post corresponding to the line selected in the list display G32.

On the contrary, if a selection from the kilometer post marks G41 on the map display G33 is made, the information processing apparatus 100 executes the selective display G51 for the line, which is in the lines of the list display G32 and corresponds to the kilometer post selected on the map display G33. Thereby, the user is able to easily check, from among the list display G32, the kilometer post selected on the map display G33.

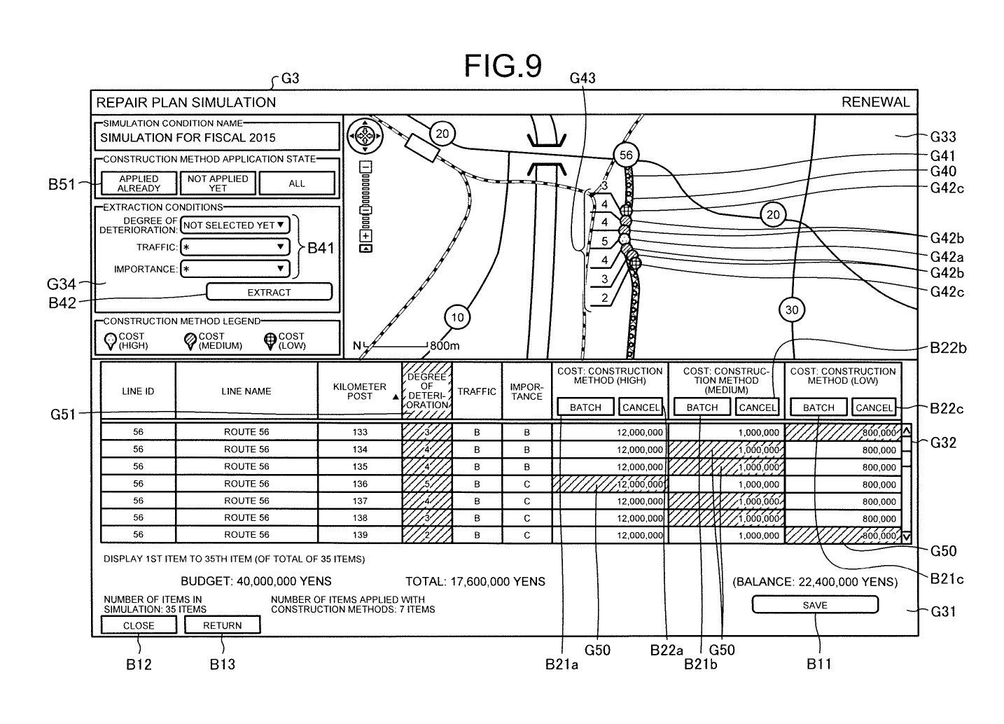

FIG. 9 is an explanatory diagram illustrating the display screen G3 of the simulation, and is a diagram illustrating a case, in which a selection of a column in the list display G32 has been received.

As illustrated in FIG. 9, “selection” includes a selection from columns (factors) of “degree of deterioration”, “traffic”, “importance”, and the like, in the list display G32 (a selection of “degree of deterioration” in the illustrated example). If a predetermined column is selected on the list display G32, the information processing apparatus 100 executes the selective display G51 for the selected column. The information processing apparatus 100 then displays the selection marks G43 at kilometer posts, which are from the kilometer post marks G41 on the map display G33 and correspond to lines being displayed in the list display G32. Further, at the respective selection marks G43, data of the selected column are written. In the illustrated example, since “degree of deterioration” is being selected in the list display G32, a numerical value of the degree of deterioration is written at each of the selection marks G43. Thereby, the user is able to easily check, from among the respective kilometer posts on the map display G33, the data corresponding to the column (factor) selected in the list display G32.

Further, the operation through the GUI includes “save” of the simulation result through the operation button B11. In the case of this “save”, the information processing apparatus 100 saves, with respect to the construction methods of the respective kilometer posts, the simulation result having the contents selected through the selective display G50, as a determined road construction plan (S19), and ends the processing.

Back to FIG. 2, based on the road construction plan determined in the budget simulation processing at S5, the information processing apparatus 100 executes order processing for ordering construction (S6). Specifically, based on the kilometer posts determined to be subjected to the construction, the construction methods, the cost, and the like; processing, such as generation of an application or the like, registration in a database related to budgets, and the like, is executed.

All or any part of the various processing functions executed by the information processing apparatus 100 may be executed on a CPU (or a micro computer, such as an MPU or a micro controller unit (MCU)). Further, needless to say, all or any part of the various processing functions may be executed on a program analyzed and executed by a CPU (or a micro computer, such as an MPU or an MCU), or on hardware by wired logic.

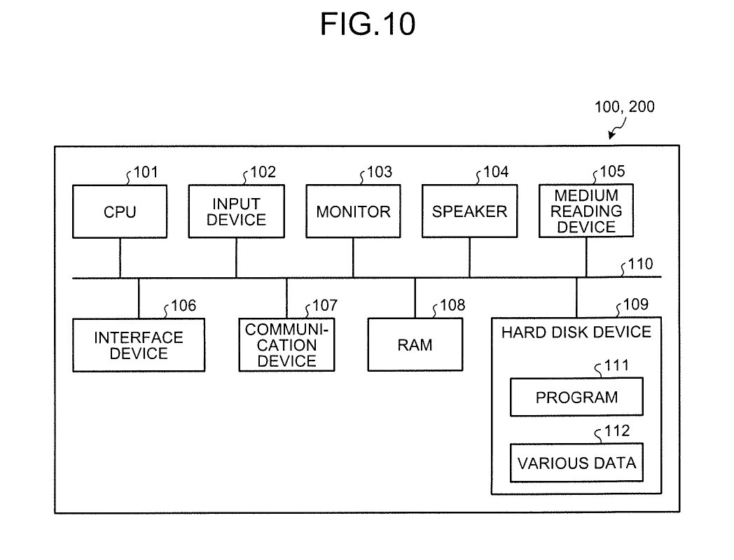

The various types of processing described in the above embodiment may be realized by a computer executing a program, which has been prepared beforehand. Accordingly, hereinafter, an example of a computer (hardware) that executes a program having functions that are the same as those of the above described embodiment will be described. FIG. 10 is a block diagram exemplifying a hardware configuration of the information processing apparatus 100 according to the embodiment.

As illustrated in FIG. 10, the information processing apparatus 100 has: a CPU 101 that executes various types of arithmetic processing; an input device 102 that receives input of data; a monitor 103; and a speaker 104. Further, the information processing apparatus 100 has: a medium reading device 105 that reads a program or the like from a storage medium; an interface device 106 for connecting to various devices; and a communication device 107 for communicatably connecting to an external device wiredly or wirelessly. Furthermore, the information processing apparatus 100 has: a RAM 108 that temporarily stores therein various pieces of information; and a hard disk device 109. Moreover, the respective units (101 to 109) in the information processing apparatus 100 are connected to a bus 110.

In the hard disk device 109, a program 111 for execution of the various types of processing described in the embodiment above is stored. Further, in the hard disk device 109, various data 112 for implementation of the program 111 (road surface investigation data D1, map and institution data D2, construction method data D3, or the like) are stored. The input device 102 receives, for example, input of operation information from an operator of the information processing apparatus 100. The monitor 103 displays, for example, various screens operated by the operator. To the interface device 106, a printing device or the like, for example, is connected. The communication device 107 is connected to a communication network, such as a local area network (LAN), and exchanges various pieces of information with the external device via the communication network.

The CPU 101 executes various types of processing, by reading out the program 111 stored in the hard disk device 109, expanding the program 111 into the RAM 108, and executing the program 111. The program 111 may be not stored in the hard disk device 109. For example, the program 111 stored in a storage medium that is readable by the information processing apparatus 100 may be read out and executed by the information processing apparatus 100. The storage medium readable by the information processing apparatus 100 corresponds to, for example: a portable recording medium, such as a CD-ROM, a DVD disk, or a universal serial bus (USB) memory; a semiconductor memory, such as a flash memory; or a hard disk drive. Further, this program may be stored in a device connected to a public line, the Internet, a LAN, or the like; and the information processing apparatus 100 may read out and execute the program therefrom.

As described above, the information processing apparatus 100 receives specification of a line, and receives specification of a type of road repair construction for each of plural kilometer posts (sections) included in a road corresponding to the specified line. Further, the information processing apparatus 100 executes control of displaying the construction method marks G42a to G42c corresponding to the received types, respectively in association with the plural kilometer posts on the road corresponding to the line. Therefore, the information processing apparatus 100 enables facilitation of verification upon formation of a plan of road construction through the specification of the type of road construction for each of the kilometer posts of the line.

According to an embodiment of the present invention, verification of road construction plans is able to be performed easily.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a road construction planning process comprising:
receiving specification of a line;
receiving specification of a type of road repair construction for each of plural sections included in a road corresponding to the line that has been specified; and
executing control of displaying a mark corresponding to the type that has been received, in association with each of the plural sections on the road corresponding to the line.

2. The non-transitory computer-readable recording medium according to claim 1, wherein an initial candidate for the type of road construction received for each of the plural sections is a candidate for road construction of a grade according to corresponding road information.

3. The non-transitory computer-readable recording medium according to claim 1, wherein a batch selection of candidates of the same rank are receivable for the plural sections from initial selection candidates for the respective sections.

4. The non-transitory computer-readable recording medium according to claim 1, wherein the road construction planning process further comprises:
displaying a first display part that displays thereon an evaluation result for at least a road surface situation for each of the plural road sections, and receives a selection of the type of road repair construction for each of the plural road sections;
displaying a second display part that displays thereon a map including the plural road sections, and displays thereon a section, for which a type of repair construction has already been selected, and a section, for which a type of repair construction has not been selected yet, distinguishably from each other; and
displaying, when a particular section, for which the selection has not been made yet, is specified on the map of the second display part, the particular section distinguishably from the other sections in the first display part.

5. A road construction planning method comprising:
receiving specification of a line, by a processor;
receiving specification of a type of road repair construction for each of plural sections included in a road corresponding to the line that has been specified, by the processor; and
executing control of displaying a mark corresponding to the type that has been received, in association with each of the plural sections on the road corresponding to the line, by the processor.

6. The road construction planning method according to claim 5, wherein an initial candidate for the type of road construction received for each of the plural sections is a candidate for road construction of a grade according to corresponding road information.

7. The road construction planning method according to claim 5, wherein a batch selection of candidates of the same rank are receivable for the plural sections from initial selection candidates for the respective sections.

8. The road construction planning method according to claim 5, further comprising:
displaying a first display part that displays thereon an evaluation result for at least a road surface situation for each of the plural road sections, and receives a selection of the type of road repair construction for each of the plural road sections, by the processor;
displaying a second display part that displays thereon a map including the plural road sections, and displays thereon a section, for which a type of repair construction has already been selected, and a section, for which a type repair construction has not been selected yet, distinguishably from each other, by the processor; and
displaying, when a particular section, for which the selection has not been made yet, is specified on the map of the second display part, the particular section distinguishably from the other sections in the first display part, by the processor.

9. An information processing apparatus, comprising a processor that executes a process comprising:
receiving specification of a line;
receiving specification of a type of road repair construction for each of plural sections included in a road corresponding to the line that has been specified; and
executing control of displaying a mark corresponding to the type that has been received, in association with each of the plural sections on the road corresponding to the line.

10. The information processing apparatus according to claim 9, wherein an initial candidate for the type of road construction received for each of the plural sections is a candidate for road construction of a grade according to corresponding road information.

11. The information processing apparatus according to claim 9, wherein a batch selection of candidates of the same rank are receivable for the plural sections from initial selection candidates for the respective sections.

12. The information processing apparatus according to claim 9, wherein the process further comprises:
displaying a first display part that displays thereon an evaluation result for at least a road surface situation for each of the plural road sections, and receives a selection of the type of road repair construction for each of the plural road sections;
displaying a second display part that displays thereon a map including the plural road sections, and displays thereon a section, for which a type of repair construction has already been selected, and a section, for which a type repair construction has not been selected yet, distinguishably from each other; and
displaying, when a particular section, for which the selection has not been made yet, is specified on the map of the second display part, the particular section distinguishably from the other sections in the first display part.
